(19) United States
(12) Patent Application Publication
(10) Pub. No.: US 2009/0246384 A1
(43) Pub. Date: Oct. 1, 2009

(54) APPARATUSES AND METHODS FOR COATING PATTERNED FILMS USING THE SAME

(75) Inventors: Jane-Hway Liao, Hsinchu County (TW); Lih-Hsiung Chan, Kaohsiung City (TW); Liang-You Jiang, Taipei County (TW); Kuang-Chung Chen, Sinjhuang City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/325,442

(22) Filed: Dec. 1, 2008

(30) Foreign Application Priority Data
Mar. 25, 2008 (TW) 097110516

(51) Int. Cl. B05D 1/32; B05C 11/02

(52) U.S. Cl. 427/282; 118/100

(57) ABSTRACT

Coating apparatuses and methods for coating patterned film using the same are presented. The coating apparatus includes a stage, arranged to support a substrate. A stencil is included having patterned openings, wherein the patterned openings are desired film printed patterns. A squeegee set is included, including a scraper and an auxiliary nozzle, wherein the scraper serves as a spreading device and spreads paste on the stencil and fills paste into the patterned openings, and wherein the auxiliary nozzle exerts a force on the paste in the patterned openings to transfer the paste onto the substrate.

### BACKGROUND OF THE INVENTION

1. Cross Reference to Related Applications

This application is based upon and claims the benefit of priority from a prior Taiwanese Patent Application No. 097110516, filed on Mar. 25, 2008, the entire contents of which are incorporated herein by reference.

2. Field of the Invention

The invention relates to coating apparatuses and methods for coating patterned films, and more particularly to coating apparatuses comprising a scraper and an auxiliary nozzle and methods for coating patterned films using the same.

3. Description of the Related Art

A technical bottleneck occurs when fabricating 100 μm and smaller film pattern dimensions using conventional film coating techniques. Specifically, if screen printing is used to fabricate 100 μm and smaller film patterns, clogging of the screen often occurs. Meanwhile, if inkjet printing is used to fabricate 100 μm and smaller film patterns, clogging of the nozzles also often occurs.

Under test conditions at 25° C., 1 rpm, and with spindle nos. 42-52, the viscosity of paste, used for fine pattern film applications, is approximately in a range between 1000 cps and 500000 cps. However, note that paste is too viscous for inkjet printing and too thin for screen printing. Therefore, both inkjet printing and screen printing are not suitable methods for fabricating fine patterned films.

The resolution of conventional VGA field emission displays are 640×480. For alignment convince, a dot matrix model is designed to smoothly drop ink. On a typical 20 inch VGA scale display substrate, 920000 to 1840000 dots must be formed to serve as emitters. However, it is difficult to uniformly apply paste material to such a small dot area due to difficulties in controlling the injection of the paste, deteriorating quality of the display panel, stability, and fabrication reproductivity. Thus, a high precision stencil is used to achieve desired film printing with ±10 μm precision. However, because the size of the mesh of the stencil for stencil printing is small, clogging of the stencil mesh often occurs.

FIG. 1A is a schematic view showing patterned film printing by a conventional screen printing apparatus. FIGS. 1B-1C are schematic views showing relationships among a squeegee, a screen table, and a printable substrate. Referring to FIG. 1A, a conventional screen printing apparatus includes a base 31 with a printable substrate 80 disposed thereon. A screen table 41 having desired patterned meshes 41a is disposed overlying the printable substrate 80 for printing with a gap Q therebetween. A squeegee 21 spreads paste or ink 70 on the screen table 41 so that the patterned meshes 41a of the screen table 41 is transferred to the top surface 80a of the substrate. A downward stroke of the squeegee 21 is controlled by a cylinder 22, and forward and backward strokes of the squeegee 21 are controlled by a cylinder 23.

If the viscosity of the paste or ink 70 has well-matched surface characteristics with the meshes of the screen table, a patterned film with the same pattern as the screen table meshes would be transferred to the substrate 80, as shown in FIG. 1B. If the viscosity of the paste or ink 70 is too high, the meshes will get clogged 70c as shown in FIG. 1C. Meanwhile, if the viscosity of the paste or ink 70 is too low, blotting on the substrate 80 will occur, resulting in deformation of the film patterns.

As fabrication of electronic devices progress, patterned film dimensions are shrinking, thus, increasing difficulties for fabricating patterned films. Additionally, increasing structural complexity of the patterned films is also increasing fabrication difficulties. Therefore, precise alignment and efficient paste or ink transfer ability are needed to achieve high precision patterned films.

### BRIEF SUMMARY OF THE INVENTION

Embodiments of the invention provide a film coating apparatus, comprising: a stage arranged to support a substrate; a stencil having patterned openings, wherein the patterned openings are desired film printed patterns; and a squeegee set, comprising a scraper and an auxiliary nozzle, wherein the scraper serves as a spreading device and spreads paste on the stencil and fills paste into the patterned openings, and wherein the auxiliary nozzle exerts a force on the paste in the patterned openings to transfer the paste onto the substrate.

Embodiments of the invention further provide a method for applying a patterned film layer, comprising: providing a stencil arranged on a substrate having patterned openings, wherein the patterned openings are desired film printed patterns; dispensing a paste on the stencil; scraping the paste on the stencil with a scraper, wherein the paste is spread and filled into the patterned openings; and exerting a force from an auxiliary nozzle on the paste in the patterned openings to transfer the paste onto the substrate.

### BRIEF DESCRIPTION OF THE DRAWINGS

The invention can be more fully understood by reading the subsequent detailed description and examples with references made to the accompanying drawings, wherein:

FIG. 1A is a schematic view showing patterned film printing by a conventional screen printing apparatus;

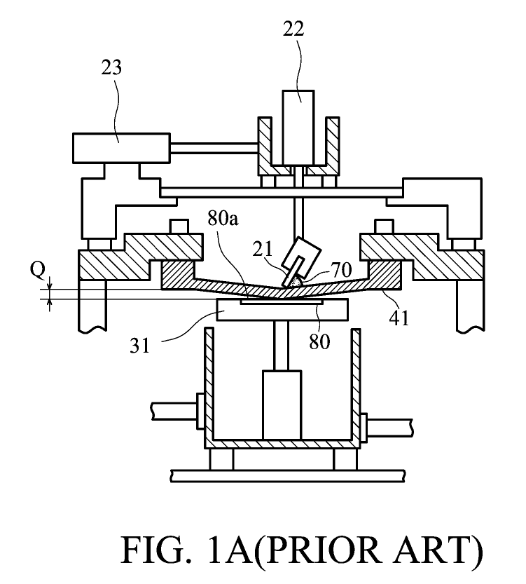

FIGS. 1B-1C are schematic views showing relationships among a squeegee, a screen table, and a printable substrate;

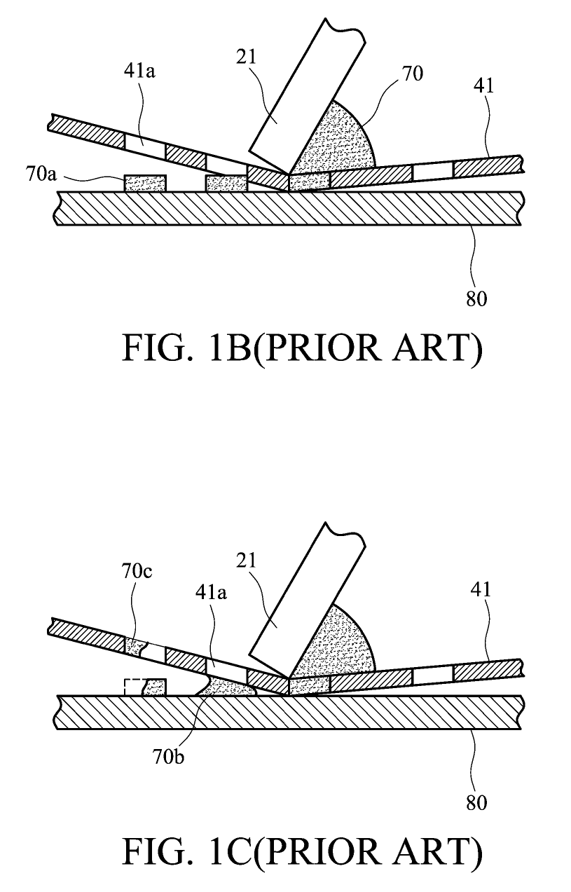

FIG. 2 is a schematic view of an embodiment of a film coating apparatus of the invention;

FIGS. 3A-3B are schematic views showing exemplary relationships among a scraper, an auxiliary nozzle, a stencil, and the paste of an embodiment of the invention;

FIG. 4 is a flow chart illustrating an embodiment of application methods for patterned films of the invention and

FIG. 5 is a schematic view of another embodiment of printing film patterns on a three-dimensional substrate structure.

### DETAILED DESCRIPTION OF THE INVENTION

It is to be understood that the following disclosure provides many different embodiments, or examples, for implementing different features of various embodiments. Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself indicate a relationship between the various embodiments and/or configurations discussed. Moreover, the formation of a first feature over or on a second feature in the description that follows may include embodiments in which the first and second features are formed in direct contact or not in direct contact.

Embodiments of the invention are directed to film coating apparatuses and methods for coating patterned films by using a squeegee set, comprising a scraper and an auxiliary nozzle. A scraper, spreads paste on a stencil with patterned openings and fills paste into the patterned openings. Subsequently, a high pressured gas or fluid jet stream is ejected from the auxiliary nozzle, forcing the paste in the patterned openings onto a printable substrate. The apparatus and method improves film stencil printing quality and stability.

Note that the embodiments of the invention combine the benefits of stencil printing with inkjet application for patterned films by using a squeegee set comprising two parts. Furthermore, a liquidphilic treatment can be alternatively and optionally performed on the surface of the stencil and a liquidphobic treatment can be alternatively and optionally performed on the wall surface of the patterned openings of the stencil, so that the paste can be uniformly spread and is more prone to be transferred to the printable substrate. For the liquidphilic treatment, the contact angle between the surface of the stencil and the paste is reduced and for the liquidphobic treatment, the contact angle between the wall surface of the patterned openings of the stencil and the paste is increased. The objective of a liquidphilic stencil surface is to facilitate uniform spreading of the paste on the stencil. Meanwhile, the objective of liquidphobic wall surfaces of the patterned openings of the stencil is to facilitate efficient transfer (no resistance) of the paste in the patterned openings onto the printable substrate.

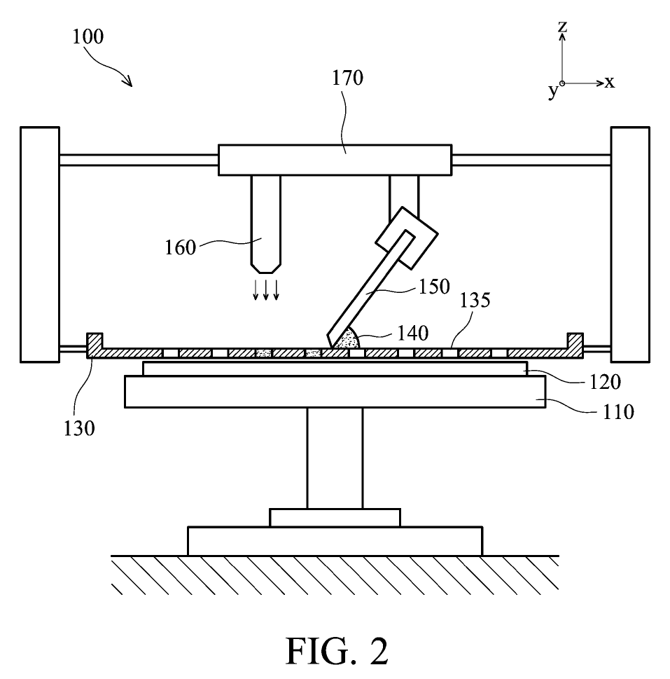

FIG. 2 is a schematic view of an embodiment of a film coating apparatus of the invention. Referring to FIG. 2, a film coating apparatus 100 includes a stage 110 to support a printable substrate 120. A stencil 130 has patterned openings 135, wherein the patterned openings 135 are desired film printed patterns. A squeegee set comprises a scraper 150 and an auxiliary nozzle 160, wherein the scraper 150 serves as a spreading device and spreads paste on the stencil 130 and fills paste into the patterned openings 135, and wherein the auxiliary nozzle 160 exerts a force on the paste in the patterned openings 135 to transfer the paste onto the printable substrate 120. Note that upward and downward strokes of the squeegee set are controlled by one cylinder (not shown), and forward and backward strokes of the squeegee set are controlled by another cylinder (not shown).

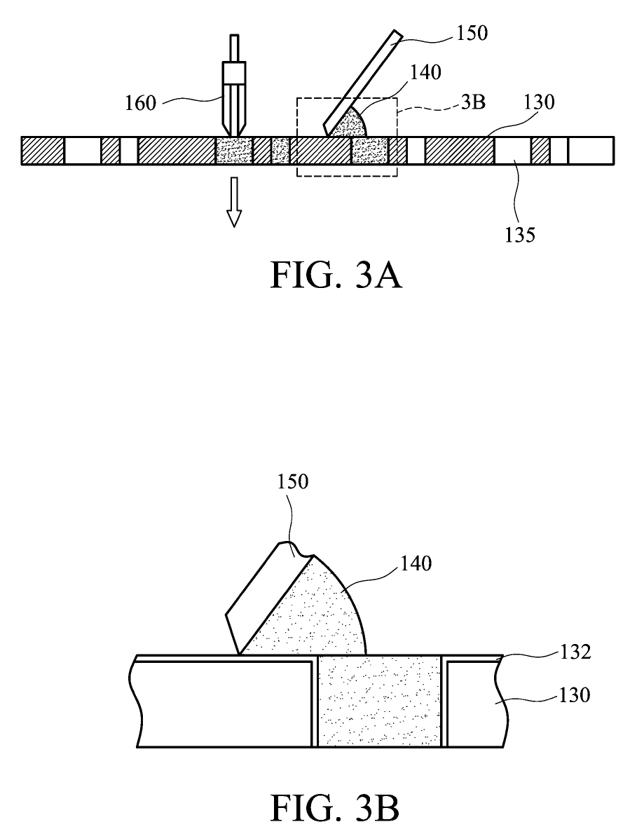

According to an embodiment of the invention, the scraper 150 and the auxiliary nozzle 160 are integrated on a fixed frame 170. According to another embodiment of the invention, the scraper 150 and the auxiliary nozzle 160 are independent from each other, however, have coordinated movement. The auxiliary nozzle 160 and the stencil 130 can be separated with a distance. Alternatively, the auxiliary nozzle 160 comprises an extended portion directly in contact with the stencil 130 as shown in FIG. 3A.

The auxiliary nozzle 160 can eject a fluid (as the arrowhead in FIG. 3A indicates) forcing the paste in the patterned openings 135 onto the printable substrate 120. The fluid comprises a liquid, a gas, or a supercritical fluid.

In addition, the auxiliary nozzle 160 can assist forcing of the paste in the patterned openings 135 onto the printable substrate 120. In another embodiment of the invention, surface treatments are performed on the surface of the stencil 130 and the inner walls of the patterned openings 135, such that they have opposite polarities. For example, a liquidphilic treatment is performed on the stencil 130 surface to facilitate uniform spreading of the paste on the stencil 130. Meanwhile, a liquidphobic treatment is performed on the wall surfaces of the patterned openings 135 of the stencil 130 to facilitate efficient transfer (no resistance) of the paste in the patterned openings 135 onto the printable substrate 120. Alternatively, an adjustable surface layer 132 can be optionally formed on the stencil 130, as shown in FIG. 3B. The adjustable surface layer 132 includes pure metal, stainless steel, alloys, polymer composites, ceramic, or plastic.

Note that the stencil 130 of some embodiments of the invention can be made of steel plates, metal plates (such as a copper plate, a gold plate, or an aluminum plate), polymer plates (such as PET or PVC), plastic plates, or paper plates.

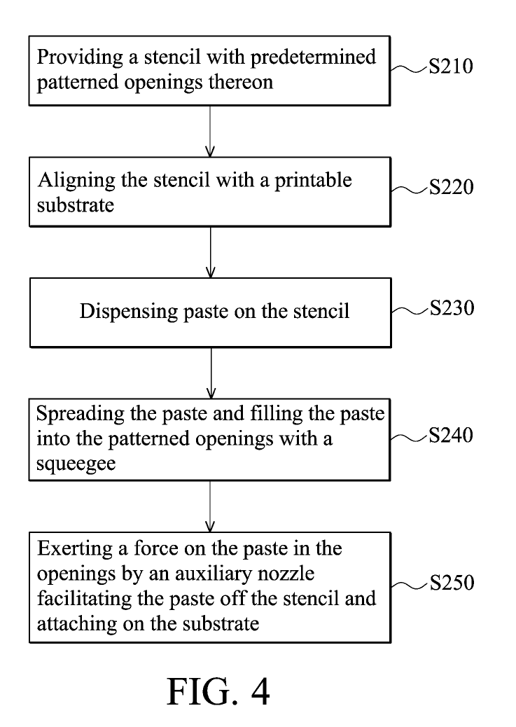

FIG. 4 is a flow chart illustrating an embodiment of application methods for patterned films of the invention. Referring to FIG. 4, the film coating techniques can be widely applicable in the optoelectronics industry, meeting high precision alignment requirements. The application methods for patterned films comprises providing a stencil with desired patterned openings thereon (step S210) and aligning the stencil with a printable substrate (step S220). Subsequently, a paste is dispensed on the stencil (step S230) and the paste is spread and filled into the patterned openings with a squeegee (step S240). A force is then exerted on the paste in the patterned openings from an auxiliary nozzle facilitating the paste to move from the stencil onto the printable substrate (step S250) for attachment.

According to an embodiment of the invention, the squeegee can be a scraper which is made of pure metals, alloys, rubbers, plastics, Teflon, or polyurethane (PU). The paste is uniformly spread on the surface of the stencil to form a film.

Next, the auxiliary nozzle can have very tiny orifices, which eject gas or fluid to force the paste in the patterned openings onto the printable substrate. The ejection method and use of the stencil having patterned openings, allows for more finely tuned patterns.

Furthermore, a liquidphilic surface of the stencil and liquidphobic walls of the patterned openings can be performed to achieve uniform coating and inking. Note that the sum of the ejection pressure of the fluid exerted by the auxiliary nozzle and the gravity of the paste should exceed the sum of the friction between the paste and the surface of the stencil and the friction between the paste and the walls of the patterned openings. The viscosity of the paste should be in a range between 10000 cps and 4000000 cps under a test condition at 1 rpm.

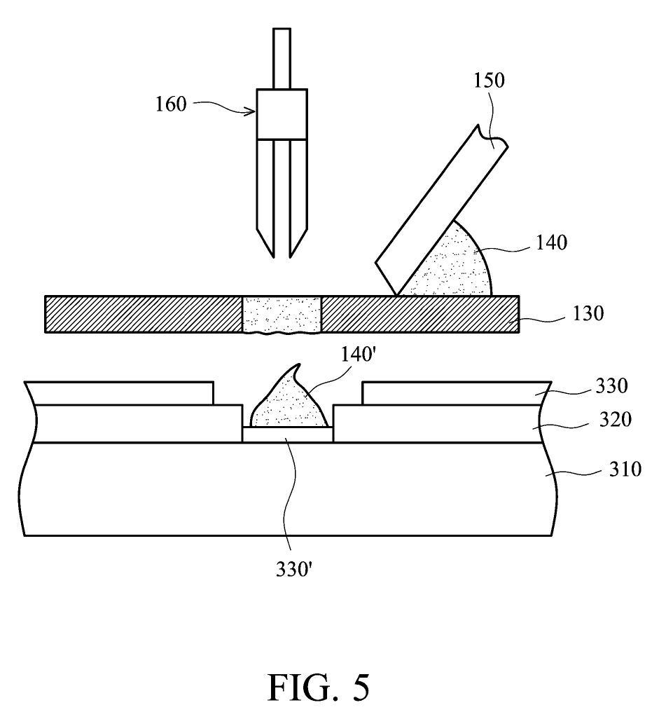

FIG. 5 is a schematic view of another embodiment of printing film patterns on a three-dimensional substrate structure. During the fabrication process of display panels (such as field emission display (FED) panels), film patterns are printed on a three dimensional substrate structure. Referring to FIG. 5, a three-dimensional substrate structure comprises a substrate 310 with a dielectric layer 320 and an opening thereon. An electrode 330′ is disposed in the opening and another electrode 330 is formed on the dielectric layer 320 adjacent to both sides of the opening composing a triode structure of an FED panel. By using the film coating apparatus 100 of FIG. 2, film patterns can be precisely applied on the three-dimensional substrate structure.

The film coating apparatuses and the application methods for film patterns can be achieved by on contact mode stencil printing. By using the auxiliary nozzle and/or performing surface treatments, more precise alignments resulting in finer dimensional printing effects and no film pattern distortion is achieved.

While the invention has been described by way of example and in terms of the embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A film coating apparatus, comprising:
a stage, arranged to support a substrate;
a stencil, having patterned openings, wherein the patterned openings are desired printed patterns; and
a squeegee set, comprising a scraper and an auxiliary nozzle, wherein the scraper serves as a spreading device and spreads paste on the stencil and fills paste into the patterned openings, and wherein the auxiliary nozzle exerts a force on the paste in the patterned openings to transfer the paste onto the substrate.

2. The film coating apparatus as claimed in claim 1, wherein the scraper and the auxiliary nozzle are integrated on a fixed frame.

3. The film coating apparatus as claimed in claim 1, wherein the scraper and the auxiliary nozzle are independent from each other, however, have coordinated movement.

4. The film coating apparatus as claimed in claim 1, wherein the auxiliary nozzle and the stencil are separated with a distance.

5. The film coating apparatus as claimed in claim 1, wherein the auxiliary nozzle comprises an extended portion directly in contact with the stencil.

6. The film coating apparatus as claimed in claim 1, wherein a fluid is injected from the auxiliary nozzle to force the paste in the patterned openings to transfer the paste onto the substrate.

7. The film coating apparatus as claimed in claim 6, wherein the fluid comprises a liquid, a gas, or a supercritical fluid.

8. The film coating apparatus as claimed in claim 1, wherein the surface of the stencil and inner surface of the patterned openings are opposite in polarity.

9. The film coating apparatus as claimed in claim 1, wherein the stencil has an adjustable surface layer thereon, comprising a pure metal, a stainless steel, an alloy, a polymer composite material, a ceramic or a plastic.

10. The film coating apparatus as claimed in claim 1, wherein the viscosity of the paste is approximately in a range between 10000 cps and 4000000 cps.

11. The film coating apparatus as claimed in claim 1, wherein the stencil is made of a stainless steel plate, a metal plate, a polymer plate, or a paper plate.

12. A method for applying a patterned film layer, comprising:
providing a stencil arranged on a substrate having patterned openings, wherein the patterned openings are desired printed patterns, the stencil;
dispensing a paste on the stencil;
scraping the paste on the stencil with a scraper, wherein the paste is spread and filled into the patterned openings; and
exerting a force from an auxiliary nozzle on the paste in the patterned openings to transfer the paste onto the substrate.

13. The method for applying a patterned film layer as claimed in claim 12, wherein the scraper and the auxiliary nozzle are integrated on a fixed frame.

14. The method for applying a patterned film layer as claimed in claim 12, wherein the scraper and the auxiliary nozzle are independent from each other, however, have coordinated movement.

15. The method for applying a patterned film layer as claimed in claim 12, wherein the auxiliary nozzle and the stencil are separated with a distance.

16. The method for applying a patterned film layer as claimed in claim 12, wherein the auxiliary nozzle comprises an extended portion, wherein the extended portion is directly in contact with the stencil.

17. The method for applying a patterned film layer as claimed in claim 12, wherein a fluid is injected from the auxiliary nozzle to force the paste in the patterned openings to transfer the paste onto the substrate.

18. The method for applying a patterned film layer as claimed in claim 17, wherein the fluid comprises a liquid, a gas, or a supercritical fluid.

19. The method for applying a patterned film layer as claimed in claim 12, wherein the surface of the stencil and inner surface of the patterned openings are opposite in polarity.

20. The method for applying a patterned film layer as claimed in claim 12, wherein the stencil has an adjustable surface layer thereon, comprising a pure metal, a stainless steel, an alloy, a polymer composite material, a ceramic or a plastic.

21. The method for applying a patterned film layer as claimed in claim 12, wherein the viscosity of the paste is approximately in a range between 10000 cps and 4000000 cps.

22. The method for applying a patterned film layer as claimed in claim 12, wherein the stencil is made of a stainless steel plate, a metal plate, a polymer plate, or a paper plate.
